(19) United States
(12) Patent Application Publication
(10) Pub. No.: US 2018/0376326 A1
(43) Pub. Date: Dec. 27, 2018

(54) RELIABLE WRITE COMMAND PROTOCOL FOR BLUETOOTH LE

(71) Applicant: QUALCOMM Incorporated, San Diego, CA (US)

(72) Inventors: Aras VAICHAS, St Ives (GB); Robin HEYDON, Cambridge (GB); Hau Tat LUK, Cambridge (GB)

(21) Appl. No.: 15/793,693

(22) Filed: Oct. 25, 2017

Related U.S. Application Data
(60) Provisional application No. 62/525,615, filed on Jun. 27, 2017.

(51) Int. Cl. H04W 8/24; H04W 84/20; G08C 17/02

(52) U.S. Cl. CPC H04W 8/245; H04W 4/008; G08C 17/02; H04W 84/20

(57) ABSTRACT

In an aspect of the disclosure, a method, a computer-readable medium, and an apparatus are provided for using reliable write command protocol. The apparatus may be configured to receive a predetermined number of segments from a first wireless device during a first connection interval. The apparatus may be configured to transmit one or more notifications to the first wireless device during the first connection interval based on an order that that the segments were received. The apparatus may be configured to receive a subsequent segment(s) from the first wireless device during a second connection interval.

CROSS-REFERENCE TO RELATED APPLICATION(S)

This application claims the benefit of U.S. Provisional Application Ser. No. 62/525,615, entitled “RELIABLE WRITE COMMAND PROTOCOL FOR BLUETOOTH LE ” and filed on Jun. 27, 2017, which is expressly incorporated by reference herein in its entirety.

### BACKGROUND

### Field

The present disclosure relates generally to communication systems, and more particularly, to a reliable write command protocol.

### Background

Wireless communication systems are widely deployed to provide various telecommunication services such as telephony, video, data, messaging, and broadcasts. In certain wireless communication systems, such as Bluetooth communication systems, several connections or connection intervals are required to transfer a file between devices. In some situations, such as during the transfer of large upgrade data, the connection between devices is interrupted and/or disconnected due to the slow transfer speed between the devices.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

### BRIEF DESCRIPTION OF THE DRAWINGS

FIGS. 1A-1B are diagrams illustrating a problem of conventional connections between devices.

FIG. 2 is a diagram illustrating an exemplary method for transferring data using a reliable write command protocol (RWCP).

FIGS. 3A-3B are diagrams illustrating a send window used in an RWCP.

FIGS. 4A-4B are diagrams of controlling flow of a segments in an RWCP.

FIG. 5 is a diagram of an exemplary RWCP segment according to aspects of the present disclosure.

FIG. 6 is a functional block diagram of a wireless device using an RWCP.

FIG. 7 is a flowchart of an exemplary method of wireless communication for transmitting information per an RWCP.

FIG. 8 is a diagram illustrating an example of a hardware implementation for an apparatus employing a processing system.

FIG. 9 is a functional block diagram of a wireless device using an RWCP.

FIG. 10 is a flowchart of an exemplary method of wireless communication for transmitting information per an RWCP.

FIG. 11 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

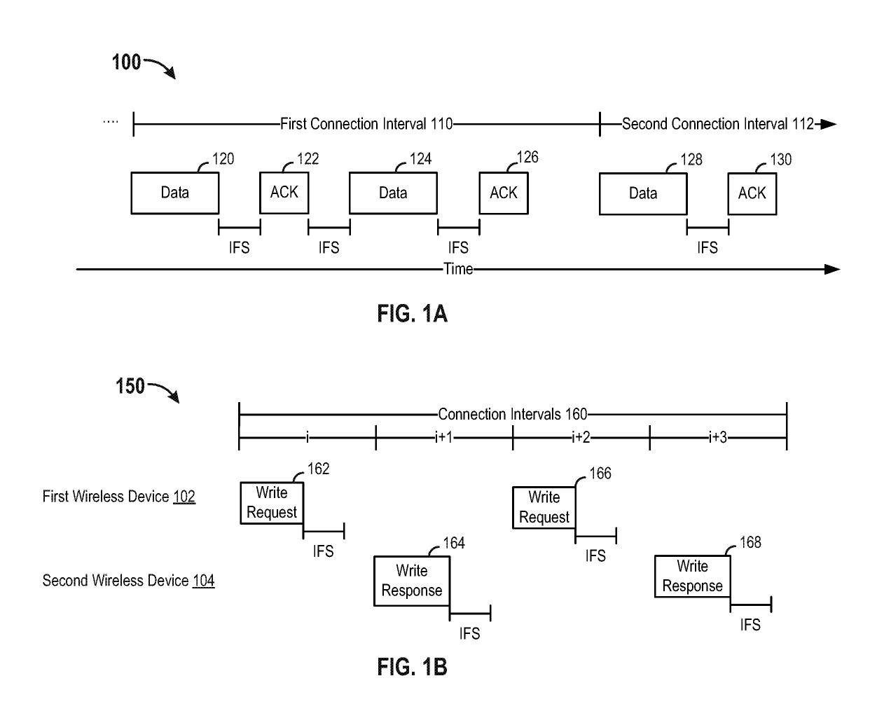

FIG. 1A is a diagram 100 illustrating data transfer between devices using a Bluetooth Low Energy (BLE) standard. FIG. 1A illustrates an interaction between two devices. Here, data 120 is transferred from a first device to a second device. In response, the second device transmits an acknowledgment (ACK) 122 to the first device. The first device then responds to the ACK 122 with more data 124, and the second device responds to the data 124 with ACK 126. The process occurs as many times as possible during a connection or connection interval (e.g., first connection interval 110). Thus, during a connection interval each device takes turns to command and reply to each other.

Under the current BLE standard a device must send a reply at a certain amount of time after the previous reply or command, otherwise the device relinquishes control of that connection interval, and waits for another connection interval before continuing the transfer of data. The reply time may be referred to as an Inter Frame Space (IFS). The IFS may be, for example, 150 us (microseconds). Thus, in this example, the firmware for each of the devices controls the radios in each of the devices such that each reply or “frame” (e.g., a reply to data 120 or a reply to ACK 122) occurs at 150 us from the end of the previous frame. In this example, ACK 122, data 124, and ACK 126 may be examples of replies that are at an IFS of the previous frame. Further, data 128 may be an example of a reply to a previous frame (e.g., ACK 126) that was unable to be at an IFS of that previous frame. Here, because the first device was unable to reply at the appropriate IFS of the first connection interval 110, the first device relinquishes control of the first connection interval 110 and waits for the second connection interval 112 to transmit data 128. Once data 128 is transmitted, interactions continue between the first and second devices as described supra, as shown by ACK 130.

In the background of the first and second devices, each device may include a control chip (e.g., a BLE controller chip) that may contain both a radio (i.e., hardware) and firmware (i.e., software) to control the interactions. The firmware is configured to control the radio to maintain the link between devices. As an example, when an application of the first device needs to transfer data (e.g., data 120), the firmware receives the data to be transferred to the second device from the application. The firmware then stores the data in a buffer and controls the radio to wait until the appropriate time to send the data (e.g., in a connection interval, and at the IFS time of the previous frame). When the radio needs to send the next frame, the radio looks in the buffer to see if there is anything to send. If the buffer is empty, then the radio relinquishes control of the connection interval.

Further, for many devices, a significant amount of time (e.g., 3000 us) may be required to reply to a frame. Thus the BLE devices may not be able to reply at the IFS point and therefore the connection interval is relinquished before replying. An example of the two devices is shown by FIG. 1B. Here, when a first wireless device 102 transfers data to a second wireless device 104, several connection intervals may be consumed. For example, a process of transferring data from the first wireless device 102 to the second wireless device 104, may require the first wireless device 102 to communicate using reliable commands, such as write request 162 or write response 164, to the second wireless device 104. A reliable command may be any segment, such as a write request, that requires an ACK in response to the reliable command before sending another reliable command. For example, once a device transmits a write request, the device waits for a write response, which is an ACK in response to a received write request, before sending a write request. The reliable command and the ACK may therefore be considered sequential commands as the ACK follows the reliable command. In an example, the first wireless device 102 transmits a write request 162 to the second wireless device 104. The first wireless device 102 waits to receive an ACK, such as write response 164, in response to the write request. Once the ACK is received, the first wireless device 102 then may send another reliable command, e.g., write request 166, to the second wireless device 104. Again, the first wireless device 102 waits to receive a response, such as a write response 168, in return. Because the processing time between receiving a write request and preparing a write response may be larger than the IFS, there may be no way to send a write response before losing control of the current connection interval. Thus, each of the data transmissions between the first wireless device 102 and the second wireless device 104 may consume a connection interval (e.g., i, i+1, i+2, i+3, where i is a first connection interval, i+2 is a second connection interval, etc.).

Because of the time required to reply to a frame and due to the size of some data transfers, such as firmware upgrades, transferring data between the first wireless device 102 and the second wireless device 104 may be slow. For example, a typical connection interval may have a 30 ms duration, and a transfer rate of data between connected devices may be as low as 100 bytes/second, once an upgrade protocol overhead is taken into to account. In this example, a large file (e.g., 30 Kbytes) having an upgrade data packet size of 20 bytes may require 3-4 connection intervals per packet and may take several minutes to be transferred. Because the transfer is slow, interferences from communications by other devices may interrupt the transfer of data between the connected devices. Further, due to the extended time of downloading large files, power consumption by the devices may be increased.

The present disclosure allows a device to increase the number of commands sent during the connection interval by sending large blocks of data using unreliable commands, such as write commands and notifications, to keep the radio buffer full, and therefore avoid, or reduces the chance of, losing control of the connection interval. Further, the present disclosure provides a sliding window protocol to cap the number of unreliable commands that have not been acknowledged in the network at any given time and to prevent a receiving device from discarding received commands. Moreover, the present disclosure increases the reliability of the system when unreliable commands are used for data transfers by sequentially numbering the unreliable commands, and providing a way to detect, notify, and resend unreliable commands that were discarded or lost.

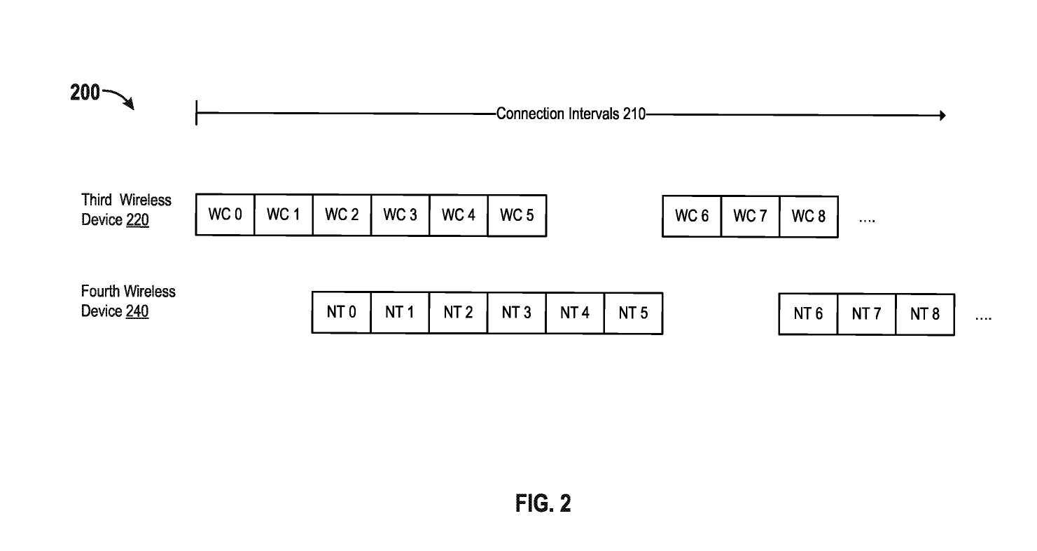

FIG. 2 is a diagram illustrating an exemplary method for transferring data using a reliable write command protocol (RWCP). In FIG. 2, a third wireless device 220 transfers data to a fourth wireless device 240. The third wireless device 220 may act as a transmitting device to transfer data to the fourth wireless device 240. Examples of the third wireless device 220 may include a wireless phone, a smart phone, a laptop computer, a user equipment, a station, or tablet. The fourth wireless device 240 acts as a receiving device to receive data from the third wireless device 220. Examples of the fourth wireless device 240 may include a peripheral device such as a wireless speaker or headset.

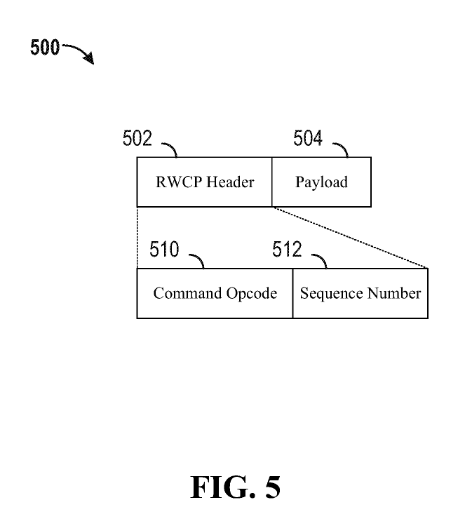

In this exemplary process, the third wireless device 220 transmits unreliable commands, such as write commands WC 0-WC 5, in a sequential order to the fourth wireless device 240. An unreliable command may be any segment, such as a write command or a notification, that does not require an ACK. Further, an unreliable command may be any segment that does not need to be spaced from another segment due to IFS or need to wait for an ACK in response to the unreliable command. In this application, a write command may be an unreliable command transmitted by a transmitting device (e.g., third wireless device 220) and a notification may be an unreliable command transmitted by a receiving device (e.g., fourth wireless device 240). Further detail regarding segments is described below in reference to FIG. 5. Because an ACK is not required in response to a unreliable command, the third wireless device 220 may transmit unreliable commands in bursts, as shown by FIG. 2, without losing control of the connection interval. A burst of transmissions may allow the third wireless device 220 to transmit a large amount of data and therefore may reduce the transmit time as compared to the transmit time when reliable commands (e.g., write requests) are used. Further, the third wireless device 220 may transmit a second burst of unreliable commands, such as write commands WC 6-WC 8, during the current connection interval without waiting for a next connection interval. Thus, in this exemplary embodiment, the firmware of the third wireless device 220 may keep a transmit buffer full of unreliable commands such that the hardware of the third wireless device 220 is able to transmit unreliable commands, when appropriate, by transmitting each successive command immediately or without delay, whether during the first connection interval or during subsequent connection intervals (e.g., irrespective of the connection interval). In other words, each of the unreliable commands transmitted by the third wireless device 220 may be transmitted unspaced from a previous or subsequent unreliable command such that unreliable commands may be sent in bursts. Further, the third wireless device 220 may sequentially number each unreliable command, when generated, to provide increased reliability in transferring data by providing a method to detect, notify, and resend unreliable commands that have been sent out but have not been acknowledged, as will be discussed in further detail below. By using unreliable commands and preventing the buffer of unreliable commands from becoming empty prior to all the data being transmitted, the third wireless device 220 may increase the data rate through transmission of unreliable commands without the need to space the commands due to IFS or need to wait for an ACK from the fourth wireless device 240. The fourth wireless device 240 may transmit a notification (e.g., NT 0-NT 8) in response to each of the received unreliable commands. Similar to the write commands, the notifications may be sent in bursts as well. Each of the notifications may include an acknowledgement of a corresponding write command. For example, NT 0 is an ACK of WC 0, NT 1 is an ACK of WC 1, NT 2 is an ACK of WC 2, etc. While the fourth wireless device 240 has been described as transmitting a notification with a one-to-one correlation with received unreliable commands, other schemes may be employed by exemplary embodiments of the present disclosure. For example, a single notification may be transmitted by the fourth wireless device 240 to ACK receipt of all previously received unreliable commands received in sequential order. For example, after having received WC 0-WC 8 in sequential order, the fourth wireless device 240 may transmit a single notification NT 8 to ACK receipt of WC 0-WC 8.

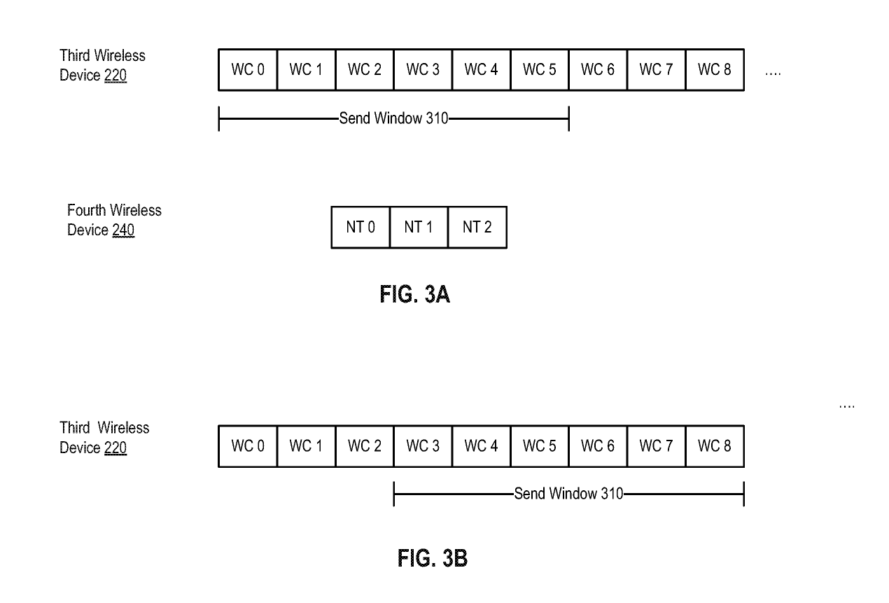

FIGS. 3A-3B are diagrams illustrating a send window 310 used in an RWCP. In some aspects, an RWCP may use a sliding window based approach to assist in flow control by a transmitting device. As discussed above, use of unreliable commands does not require an ACK in response to receipt of the write commands. In theory, the firmware could fill the buffer with segments, including unreliable commands, which would allow the radio to continuously transmit frames. However, in this example, a receiving device may become over whelmed by large bursts of segments and may discard one or more of the segments. To reduce the number of segments discarded, a sliding window based approach may be used. In a sliding window based approach, the transmitting device may be limited to a predetermined number of unreliable commands that are outstanding (i.e., unreliable commands that have not been acknowledged) before the transmitting device waits for receipt of a notification. In an example, the predetermined number of unreliable commands in a send window may be 6, as shown by FIGS. 3A-3B. However, in other embodiments, the predetermined number of unreliable commands per send window may be any number. As shown by FIG. 3A, a third wireless device 220 retains in a buffer a number of write commands (e.g., WC 0-WC 8) to be transmitted. The number of write commands in the buffer are the number of commands that the radio has access to transmit. The firmware of the third wireless device 220 manages the send window 310 to keep track of which unreliable commands have been transmitted and which unreliable commands are outstanding at any given time. The third wireless device 220 adjusts the send window 310 when a corresponding notification has been received from the fourth wireless device 240. In an example, as the third wireless device 220 receives a notification (e.g., NT 0-NT 3) from the fourth wireless device 240, the send window 310 may be adjusted to include additional unreliable commands transmitted in response to the notification (e.g., WC 6-WC 8) while removing from the window the unreliable commands that have been acknowledged (e.g., WC 0-WC 3). In doing so, the third wireless device 220 may send the additional unreliable commands (e.g., WC 6-WC 8) but remains limited to the number of WCs transmitted but not yet acknowledged that is equal to the predetermined number of unreliable commands allowed by the send window 310. As described, the predetermined number of unreliable commands in a send window may be any number. This may include varying the predetermined number of outstanding unreliable commands in the send window 310 based on communication congestion between wireless devices. For example, the predetermined number of unreliable commands in the send window 310 may be reduced (e.g., from a window size of 6 to a window size of 4) when congestion between the third wireless device 220 and the fourth wireless device 240 is detected. Additionally, the predetermined number in the send window may be increased (e.g., from a window size of 6 to a window size of 8) according to a rate of successfully transferred segments between the third wireless device 220 and the fourth wireless device 240. Accordingly, a transmitting device (e.g., the third wireless device 220) keeps track of sequence numbers of segments to know which segments have been transmitted, which segments to transmit next, and which segments are outstanding. Further, the receiving device (e.g., the fourth wireless device 240) keeps track of sequence numbers of segments to know which segments are expected to be received based on the largest sequence number previously received. Additional examples of a transmitting device and a receiving device keeping track of sequence numbers of segments are described below.

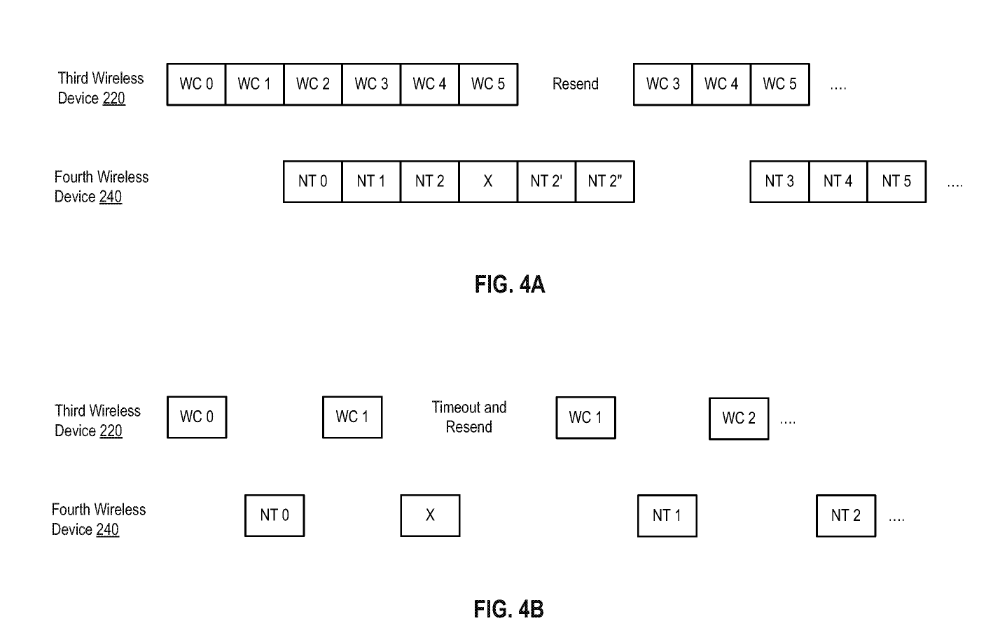

FIG. 4A is a diagram illustrating control of an out-of-sequence segment in an RWCP. In an aspect, the RWCP allows a receiving device to provide a positive indication of a missing unreliable command, as illustrated by FIG. 4A. In an example, the receiving device acknowledges all received unreliable commands, even if they arrive out of sequence. In doing so, the transmitting device may recognize that an unreliable command has been received by the receiving device out of sequence and may retransmit unreliable commands beginning from an unreliable command that has not been acknowledged and is next in sequential order to be acknowledged. For example, as shown by FIG. 4A, the third wireless device 220 may transmit a burst of unreliable commands (e.g., WC 0-WC5) in sequential order to the fourth wireless device 240. In response, the fourth wireless device 240 may transmit notifications corresponding in receipt of the unreliable commands. However, if one of the unreliable commands (e.g., WC 3) is not received in sequence by the fourth wireless device 240, as indicated by the X, the fourth wireless device 240 may detect the out-of-sequence segments and may inform the third wireless device 220 by sending a gap notification. For example, FIG. 4A illustrates an example of the fourth wireless device 240 failing to receive WC 3 or failing to receive WC 3 in sequential order. Accordingly, the fourth wireless device 240 may receive segments in the following order, WC 0-WC 2, WC 4, and WC 5. The fourth wireless device 240 may determine that the received segments are out of sequence and, after having sent NT 0-NT 2, may send a gap notification for each out-of-sequence segment. In this example, two gap notifications are sent, NT 2′ is sent in response to WC 4 and NT 2″ is sent in response to WC 5. Here, NT 2′ and NT 2″ are notifications that include a gap notification along with the ACK of the last received write command, WC 2. The fourth wireless device 240 then waits to receive WC 3. However, in another example, only one gap segment may be sent to indicate that one or more data segments were not received in order. For example, in the above example, the fourth wireless device 240 may transmit NT 2′, and not NT 2″, in response to WC 4 and then may wait to receive a retransmission of WC 3. By sending only one gap segment to indicate that one or more data segments were received out of sequence, network congestion may be reduced. The third wireless device 220 may then resend the unreliable commands that were not received in order by the fourth wireless device 220, and any other unreliable commands that were already sent but not acknowledged, beginning from the unreliable command that has not been acknowledged and is next in sequential order of WCs transmitted but not acknowledged. For example, as shown by FIG. 4, the third wireless device 220 may resend WC 3-WC 5.

In an embodiment, the third wireless device 220 may be limited to the number of unreliable commands to resend based on the predetermined number of unreliable commands allowed by the send window. For example, using the examples of FIGS. 3 and 4, because WC 0-WC 2 have been acknowledged by corresponding NT 0-NT 2, the third wireless device 220 may resend WC 3-WC 5 because of the out-of-order sequence described above and may also send WC 6-WC 8 as part of a burst transmission including WC 3-WC 5 to the fourth wireless device 240, based on the send window 310 being set to six. In other words, the fourth wireless device 240 may resend commands starting with the first WC that has not received a corresponding ACK (e.g., WC 3) and sends in sequence the next five WCs (e.g., WC 4-WC 8).

FIG. 4B is a diagram illustrating control of a missing sequence segment in an RWCP. In an aspect, the RWCP allows a transmitting device to resend an unreliable command if no ACK has been received, as illustrated by FIG. 4B. In an example, after the transmitting device transmits an unreliable command, the transmitting device expects to receive a corresponding notification from the receiving device within in a given time. If no corresponding notification is received within the given time, a timeout occurs and the transmitting device will retransmit the unreliable command. For example, as shown by FIG. 4B, the third wireless device 220 may transmit unreliable commands (e.g., WC 0-WC 1) in sequential order to the fourth wireless device 240. The unreliable commands may be transmitted individually or in bursts. The firmware for the third wireless device 220 starts timers corresponding to the times expected to receive corresponding notifications for each of the unreliable commands. After receiving a notification NT 0 corresponding to WC 0, a timer corresponding to WC 0 may stop but the timer corresponding to WC 1 continues to run as the firmware for the third wireless devices expects to receive a corresponding notification for WC 1. Once the timer reaches a predetermined time without having received a corresponding notification for WC 1, the third wireless device 220 may enter a timeout state to allow the third wireless device 220 to resend WC 1 to the fourth wireless device 240. When WC 1 is resent, the corresponding timer may be reset and restarted, by the firmware, to the time expected for the corresponding next notification.

For any of the aspects described supra or infra, if more than one of the same unreliable commands (e.g., WC 2) are received by the receiving device, the receiving device may transmit notifications to acknowledge each of the commands, since the previous acknowledgement(s) may have not have been received by the transmitting device. Further, if more than one notification corresponding to the same unreliable command is received by the transmitting device, the transmitting device may ignore the duplicate notifications as the transmitting device has already marked the corresponding unreliable command as acknowledged.

FIG. 5 is a diagram of an exemplary RWCP segment 500 according to aspects of the present disclosure. In an example, a RWCP segment 500 (e.g., a write command or a notification) may include an RWCP header 502 and, for transmitting data, a payload 504. The size of the RWCP header 502 may be a predetermined size (e.g., one octet), while an RWCP payload may be limited depending on characteristics or capabilities of the connected devices. For example, the RWCP payload 504 may have a maximum payload size of 19 octets for non-data length extension (DLE) enabled devices and a maximum payload size of 247 octets for DLE enable devices.

The RWCP header 502 may include a command opcode field 510 and a sequence number field 512. The command opcode field 510 may indicate a type of segment being transmitted or received. In an example, if the RWCP header 502 is an octet, the command opcode field 510 may include two bits to indicate the segment type and the sequence number field 512 may include six bits for indicating the sequence number of the segment. For example, a transmitting device (e.g., the third wireless device 220) may generate a segment (e.g., a write command) having opcode bits of 00 that may indicate data being sent, opcode bits of 01 that may indicate a synchronization (SYN), or start a session, is being requested, or opcode bits of 10 that may indicate a reset (RST), or termination of a session, is being sent. In another example, a receiving device (e.g., the fourth wireless device 240) may generate a segment (e.g., a notification) having opcode bits of 00 that may indicate an ACK of data received, opcode bits of 01 that may indicate an ACK of a SYN received, opcode bits of 10 that may indicate an ACK of a RST received, or opcode bits of 11 that may indicate a gap, which indicates that the received segment was out-of-sequence.

The sequence number field 512 may indicate the sequence order of a current segment being transmitted, a segment being acknowledged, or a segment previously having been acknowledged. For example, for an opcode indicating a request for SYN, the sequence number field 512 may include sequence bits (e.g., 000001) to indicate the first sequence number, and, for an opcode indicating a ACK to a SYN, the sequence number field 512 may include sequence bits (e.g., 000001) corresponding to the SYN. As another example, for an opcode indicating a request for RST or an ACK for a RST, the sequence number field 512 may be null or blank. As another example, for an opcode indicating data is being transmitted, the sequence number field 512 may include sequence bits (e.g., 000100) indicating a current sequence number i, and for an opcode indicating a ACK to data being received, the sequence number field 512 may include sequence bits (e.g., 000100) indicating receipt of the data. As another example, for an opcode indicating a gap, the sequence number field 512 may include sequence bits (e.g., 000011) indicating the last sequence number of a segment that was received in order.

Based on the above description of the RWCP segment 500, the RWCP segment 500 may be bidirectional, meaning a transmitting device (e.g., third wireless device 220) and a receiving device (e.g., fourth wireless device 240) may transmit or receive write commands or notifications. In a first example, a transmitting device may use a write command to send data or send an ACK, and a receiving device may use a notification to send an ACK or send data, however, each segment (e.g., the write command or the notification) may only contain a data portion, or an ACK portion, but not both at the same time, as described above. However, one skilled in the art would recognize that the present application is not limited to this first example, and, in some embodiments, a segment (e.g., the write command or the notification) may include both a data portion and an ACK portion. In a second example, both the transmitting device and the receiving device may transmit and receive data and ACKs at the same time using the commands (e.g., WC and NT) available to them. In this example, a RWCP header may include first and second command opcode fields and first and second sequence number fields. The first command opcode field and the first sequence number field may correspond to data being transmitted by a device, and the second command opcode field and the second sequence number field may correspond to an ACK of data that was received by the device. By using the second example, both the transmitting device and the receiving device may use a same header format that is symmetrical for both devices.

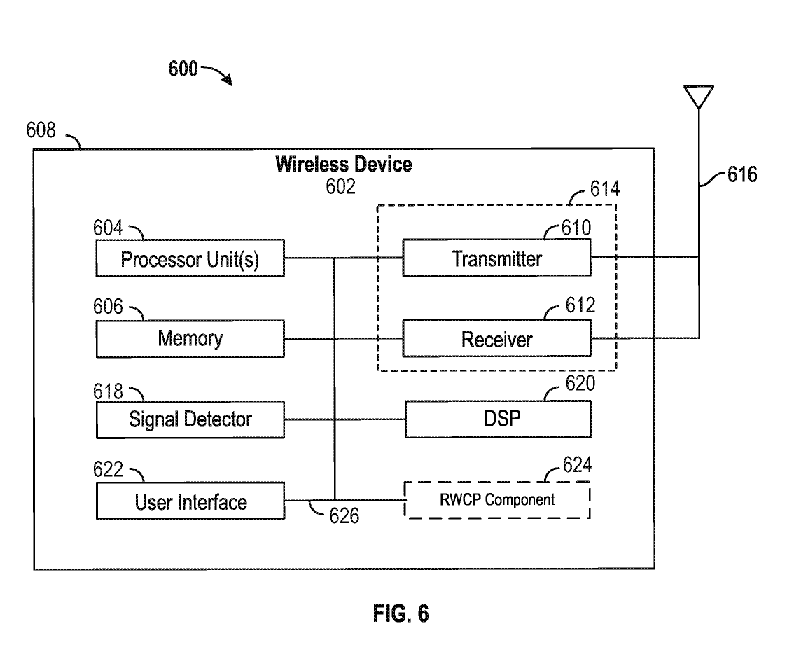

FIG. 6 is a functional block diagram 600 of a wireless device 602 that may be employed within the wireless communication system for using an RWCP. The wireless device 602 is an example of a device that may be configured to implement the various methods described herein. For example, the wireless device 602 may be a phone or tablet.

The wireless device 602 may include a processor 604 which controls operation of the wireless device 602. The processor 604 may also be referred to as a central processing unit (CPU). Memory 606, which may include both read-only memory (ROM) and random access memory (RAM), may provide instructions and data to the processor 604. A portion of the memory 606 may also include non-volatile random access memory (NVRAM). The processor 604 typically performs logical and arithmetic operations based on program instructions stored within the memory 606. The instructions in the memory 606 may be executable (by the processor 604, for example) to implement the methods described herein.

The processor 604 may include or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 602 may also include a housing 608, and the wireless device 602 may include a transmitter 610 and/or a receiver 612 to allow transmission and reception of data transmissions between the wireless device 602 and a remote device. The transmitter 610 and the receiver 612 may be combined into a transceiver 614. An antenna 616 may be attached to the housing 608 and electrically coupled to the transceiver 614. The wireless device 602 may also include multiple transmitters, multiple receivers, multiple transceivers, and/or multiple antennas.

The wireless device 602 may also include a signal detector 618 that may be used to detect and quantify the level of signals received by the transceiver 614 or the receiver 612. The signal detector 618 may detect such signals and quantify the detected signals based on total energy, energy per subcarrier per symbol, power spectral density, and other signal measurements. The wireless device 602 may also include a digital signal processor (DSP) 620 for use in processing signals. The DSP 620 may be configured to generate a packet for transmission. In some aspects, the packet may include a PPDU.

The wireless device 602 may further include a user interface 622 in some aspects. The user interface 622 may include a keypad, a microphone, a speaker, and/or a display. The user interface 622 may include any element or component that conveys information to a user of the wireless device 602 and/or receives input from the user.

When the wireless device 602 is implemented as a client or transmitting device, the wireless device 602 may also include a RWCP component 624 that may perform burst segment transmission with a remote device. In one configuration, the wireless device 602 may include means for transmitting a first set of segments of a plurality of segments to a second wireless device. Each of the segments of the first set of segments may be an unreliable command. In another configuration, the wireless device 602 may include means for determining whether a notification corresponding to one or more first segments of the first set of segments has been received from the second wireless device. In a further configuration, the wireless device 602 may include means for determining a second set of segments of the plurality of segments to be transmitted based on whether the notification has been received. In another configuration, the wireless device 602 may include means for transmitting the second set of segments to the second wireless device. In an example, each segment of the second set of segments may be an unreliable command.

In some aspects, the wireless device 602 may include means for sequentially numbering the plurality of segments. The first set of segments and the second set of segments may be transmitted in a sequential order based on the sequential numbering of the plurality of segments.

In some aspects, the means for generating the second set of segments may generate the second set of segments based on a send window. In an example, the means for generating the second set of segments may determine which of the one or more first segments in the first set of segments are within the send window and have not been acknowledged. In an example, the wireless device 602 may include means for varying a size of the send window based on communication congestion between the apparatus and the second wireless device

In some aspects, the means for determining whether a notification has been received may determine that no notification has been received. When no notification has been received, the means for generating the second set of segments may determine a segment that has not been previously acknowledged and is next in the sequential order to be acknowledged and may include the segment in the second set of segments.

In some aspects, the wireless device 602 may include means for verifying a content of the notification when determined that the notification has been received. In an example, the means for generating the second set of segments may generate the second set of segments based on the content of the notification.

In some aspects, the means for verifying the content of the notification may determine that the content of the notification includes an acknowledgment of the one or more first segments of the first set of segments received in the sequential order. In an example, based on the content of the notification, the means for generating the second set of segments may determine a segment that has not been previously transmitted and is next in the sequential order to be transmitted and may include the segment in the second set of segments

In some aspects, the means for verifying the content of the notification may determine that the content of the notification indicates that the one or more first segments of the first set of segments was received by the second wireless device out of sequence. In an example, based on the content of the notification, the means for generating the second set of segments may determine a segment that has not been previously acknowledged and is next in the sequential order to be acknowledged and may include the segment in the second set of segments.

In some aspects, the means for verifying the content of the notification may determine that the content of the notification indicates that one or more first segments of the first set of segments was not received by the second wireless device. In an example, based on the content of the notification, the means for generating the second set of segments may determine a segment that has not been previously acknowledged and is next in the sequential order to be acknowledged and may include the segment in the second set of segments.

In some aspects, the wireless device 602 may include means for storing the plurality of segments in a buffer of the transmitting device. The sequential order may be based on a sequential order of the plurality of segments in the buffer and the first set of segments and the second set of segments may be selected from the stored plurality of segments.

The various components of the wireless device 602 may be coupled together by a bus system 626. The bus system 626 may include a data bus, for example, as well as a power bus, a control signal bus, and a status signal bus in addition to the data bus. Components of the wireless device 602 may be coupled together or accept or provide inputs to each other using some other mechanism.

Although a number of separate components are illustrated in FIG. 6, one or more of the components may be combined or commonly implemented. For example, the processor 604 may be used to implement not only the functionality described above with respect to the processor 604, but also to implement the functionality described above with respect to the signal detector 618, the DSP 620, the user interface 622, and/or the RWCP component 624. Further, each of the components illustrated in FIG. 6 may be implemented using a plurality of separate elements.

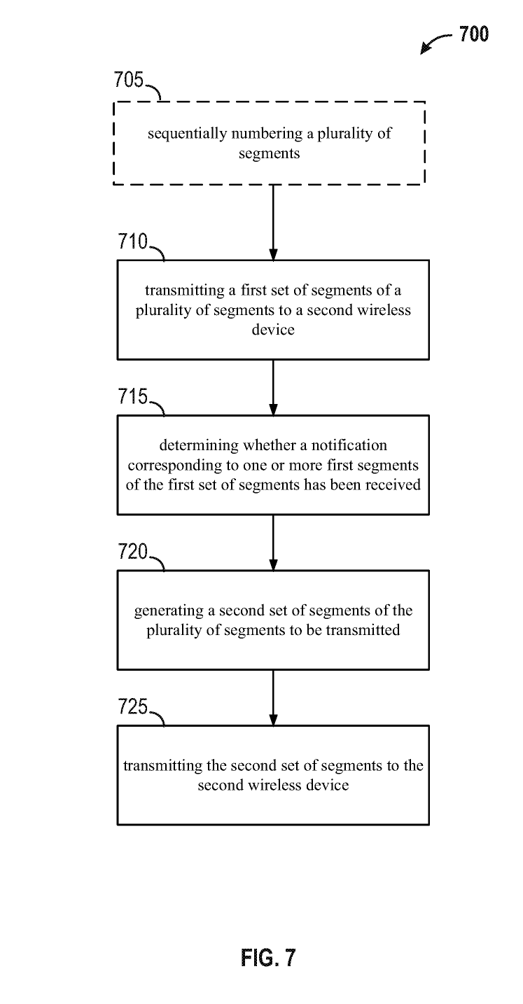

FIG. 7 is a flowchart of an exemplary method 700 of wireless communication for transmitting information per an RWCP. The method 700 may be performed using an apparatus (e.g., the third wireless device 220). Referring to FIG. 7, at 705, the apparatus may sequentially number a plurality of segments. For example, as shown by FIG. 2, each of the segments WC 0-WC 8 is sequentially numbered. Further, as shown by FIG. 5, segments may be numbered via a sequence number field 512 in an RWCP header 502 of the segment. In an example, a first set of segments and a second set of segments may be transmitted in a sequential order based on the sequential numbering of the plurality of segments, as shown by FIGS. 2, 3A-3B, and 4A-4B. In some aspects, the plurality of segments may be stored in a buffer. Further, the sequential order may be based sequential numbering of the plurality of segments in the buffer. For example, as shown by FIGS. 2, 3A-3B, and 4A-4B, the apparatus may include a buffer or memory to store a plurality of segments (e.g., WC 0-WC 8). The apparatus may sequentially number the segments 0-8. However, one skilled in the art would understand that the apparatus is not limited to a buffer/memory storing and sequentially numbering 8 segments and in other examples the buffer/memory may store and sequentially number any number of segments.

At 710, the apparatus may transmit a first set of segments of a plurality of segments to a second wireless device. For example, referring to FIGS. 2-5, the third wireless device 220 may transmit write commands WC 0-WC 5 to the fourth wireless device 240. In this example, WC 0-WC 5 may be unreliable commands, as WC 0-WC 5 are write commands and have no need to be spaced from each other due to IFS or no need to wait for an ACK from the fourth wireless device 240 in response to the write commands

At 715, the apparatus may determine whether a notification corresponding to one or more first segments of the first set of segments has been received from the second wireless device. For example, referring to FIG. 2, firmware for the third wireless device 220 may determine that one or more notifications NT 0-NT 5 have been received from the fourth wireless device 240. The firmware for the third wireless device 220 may determine that one or more notifications were received based on checking a RWCP header (e.g., 502) of a received packet. The third wireless device may determine that a received packet is a notification based on a command opcode (e.g., 510). Further, the third wireless device 220 may determine that the notification corresponds to a transmitted segment based on a sequence number (e.g., 512) of the RWCP header. For example, the sequential order of NT 0-NT 5 indicates that corresponding segments (e.g., WC 0-WC 5) were received by fourth wireless device 240 in sequential order. Alternatively, the third wireless device 220 may determine that a single notification (e.g., NT 5) has been received from the fourth wireless device 240, where the single notification indicates that a corresponding segment (e.g., WC 5) and all prior segments (e.g., WC 0-WC 4) were received by fourth wireless device 240 in sequential order. In another example, referring to FIG. 4A, the third wireless device 220 may receive a notification (e.g., NT 2′ or NT 2″) which indicates that unreliable commands were received out of order (e.g., WC 3 was not received and, instead, WC 4 is received after WC 2 by the fourth wireless device 240). In this example, third wireless device 220 receives a positive indication of the out-of-sequence segments via a gap notification from the fourth wireless device 240, where the gap notification may indicate that sequence number of the segment previously received in sequential order (e.g., WC 2). In another example, referring to FIG. 4B, firmware for the third wireless device 220 may determine that no notifications corresponding to a transmitted segment have been received from the fourth wireless device 240. In an example, firmware for the third wireless device 220 may start one or more timers corresponding to the times expected to receive corresponding notifications for each of the transmitted segments, as discussed above.

At 720, the apparatus may generate a second set of segments of the plurality of segments to be transmitted based on determining whether the notification has been received. In an example, each segment of the second set of segments may be an unreliable command. For example, as shown by FIG. 2, when the third wireless device 220 has received the notifications NT 0-NT 5, the third wireless device 220 may determine to transmit WC 6-WC 8 and/or additional write commands. In another example, as shown by FIG. 4B, when the third wireless device 220 has received the notification NT 1 corresponding to WC 0, the third wireless device 220 may generate WC 1.

In some aspects, the second set of segments may be further generated based on a send window. For example, referring to FIGS. 2, 3A-3B, that apparatus may include a send window that holds six segments at a time (i.e., the send window size is six). If WC 0-WC 5 (e.g., the first set of segments) have been acknowledged by the fourth wireless device 240 (i.e., all six WCs within the send window have been acknowledged), the third wireless device 220 may adjust the send window 310 to include WC 6-WC 8 and WC 9-WC 11 (not shown) and may send these segments to the fourth wireless device 240. However, in another example, if only WC 0-WC 2 has been acknowledged, the third wireless device 220 may adjust the send window 310 to include WC 3-WC 8 and may send WC 6-WC 8 segments to the fourth wireless device 240. As another example, referring to FIGS. 4A-4B, if WC 0-WC 2 have been acknowledged, but no additional segments have been properly acknowledged, whether due to receiving an out-of-sequence notification, a gap segment, or no notification from the fourth wireless device 240, the third wireless device 220 may adjust the send window 310 to include WC 3-WC 8 (WC 6-WC 8 not shown in FIGS. 4A-4B) and may send these segments to the fourth wireless device 240. In some examples, the apparatus may vary a size of the send window. The apparatus may adjust the size of the send window based on, for example, communication congestion between the first wireless device and the second wireless device

At 725, the apparatus may transmit the second set of segments to the second wireless device.

To initiate data transfer between two devices, the transmitting device (e.g., the third wireless device 220) may send an RWCP segment (e.g., 500) SYN to the receiving device (e.g., the fourth wireless device 240) and wait for acknowledgment. For example, referring to the above discussion of FIG. 5, the third wireless device 220 may transmit a segment having opcode bits of 01 to the fourth wireless device 240. The receiving device may receive the SYN and return an ACK of the SYN to the transmitting device. For example, the third wireless device 220 may transmit a notification having opcode bits of 01 to the fourth wireless device 240 as an ACK to the request for SYN. Once synchronized, the transmitting device may send data segments to the receiving device and the receiving device transmits acknowledging notifications, as described above. In an example, SYN of the devices may be initiated by the transmitting device by using a generic attribute profile (GATT) characteristic defined as using the RWCP.

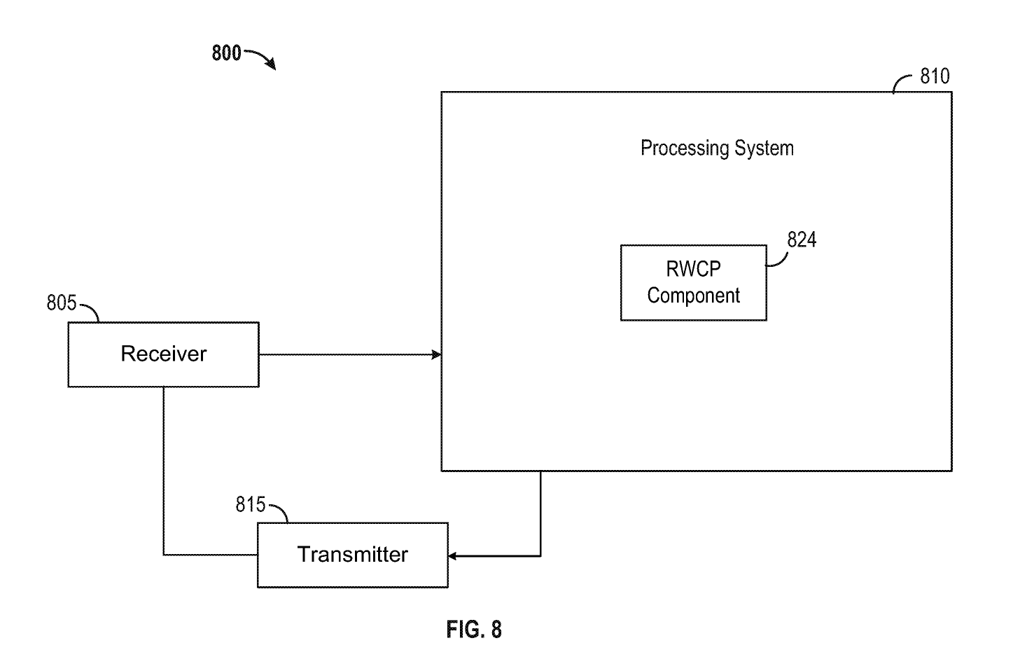

FIG. 8 is a functional block diagram of an exemplary wireless communication device 800 for using an RWCP. The wireless communication device 800 may include a receiver 805, a processing system 810, and a transmitter 815. The processing system 810 may include an RWCP component 824. In an aspect, the RWCP component 824 may be configured to transmit a first set of segments of a plurality of segments to a second wireless device. In another aspect, the RWCP component 824 may be configured to determine whether a notification corresponding to one or more first segments of the first set of segments has been received from the second wireless device. In another aspect, the RWCP component 824 may be configured to generating a second set of segments of the plurality of segments to be transmitted based on the determining whether the notification has been received. In another aspect, the RWCP component 824 may be configured to transmit the second set of segments to the second wireless device.

The receiver 805, the processing system 810, the RWCP component 824, and/or the transmitter 815 may be configured to perform one or more functions discussed above with respect to blocks 705-725 of FIG. 7. The receiver 805 may correspond to the receiver 512. The processing system 810 may correspond to the processor 504. The transmitter 815 may correspond to the transmitter 510. The RWCP component 824 may correspond to the RWCP component 524.

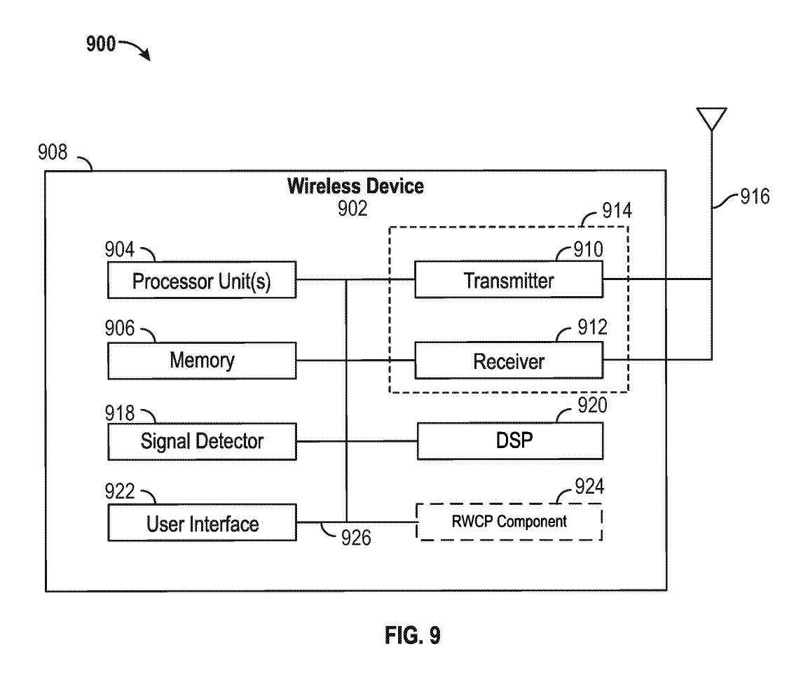

FIG. 9 is a functional block diagram 900 of a wireless device 902 that may be employed within a wireless communication system for using an RWCP. The wireless device 902 is an example of a device that may be configured to implement the various methods described herein. For example, the wireless device 902 may be a peripheral device, such as a wireless speaker or headset, configured to connect to the wireless device 502.

The wireless device 902 may include a processor 904 which controls operation of the wireless device 902. The processor 904 may also be referred to as a central processing unit (CPU). Memory 906, which may include both read-only memory (ROM) and random access memory (RAM), may provide instructions and data to the processor 904. A portion of the memory 906 may also include non-volatile random access memory (NVRAM). The processor 904 typically performs logical and arithmetic operations based on program instructions stored within the memory 906. The instructions in the memory 906 may be executable (by the processor 904, for example) to implement the methods described herein.

The processor 904 may include or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 902 may also include a housing 908, and the wireless device 902 may include a transmitter 910 and/or a receiver 912 to allow transmission and reception of data transmissions between the wireless device 902 and a remote device. The transmitter 910 and the receiver 912 may be combined into a transceiver 914. An antenna 916 may be attached to the housing 908 and electrically coupled to the transceiver 914. The wireless device 902 may also include multiple transmitters, multiple receivers, multiple transceivers, and/or multiple antennas.

The wireless device 902 may also include a signal detector 918 that may be used to detect and quantify the level of signals received by the transceiver 914 or the receiver 912. The signal detector 918 may detect such signals as total energy, energy per subcarrier per symbol, power spectral density, and other signals. The wireless device 902 may also include a digital signal processor (DSP) 920 for use in processing signals. The DSP 920 may be configured to generate a packet for transmission. In some aspects, the packet may comprise a PPDU.

The wireless device 902 may further include a user interface 922 in some aspects. The user interface 922 may comprise a keypad, a microphone, a speaker, and/or a display. The user interface 922 may include any element or component that conveys information to a user of the wireless device 902 and/or receives input from the user.

When the wireless device 902 is implemented as a server or receiving device, the wireless device 902 may also comprise a RWCP component 924 that may perform burst notification transmission with a remote device. In one configuration, the wireless device 902 may include means for receiving one or more segments from a first wireless device, wherein the one or more segments are unreliable commands. In another configuration, the wireless device 902 may include means for determining an order of receipt of the one or more segments. In another configuration, the wireless device 902 may include means for transmitting a notification to the first wireless device based on the determined order of receipt.

In some aspects, the means for determining the order of receipt is configured to determine whether there is a gap in the one or more segments based on an expected sequential order and a determined order of receipt. In some aspects, the notification may include an acknowledgment that the one or more segments were received in an expected sequential order. In some aspects, the notification may include an acknowledgment of a previously acknowledged segment to indicate that the one or more segments were not received in an expected sequential order.

The various components of the wireless device 902 may be coupled together by a bus system 926. The bus system 926 may include a data bus, for example, as well as a power bus, a control signal bus, and a status signal bus in addition to the data bus. Components of the wireless device 902 may be coupled together or accept or provide inputs to each other using some other mechanism.

Although a number of separate components are illustrated in FIG. 9, one or more of the components may be combined or commonly implemented. For example, the processor 904 may be used to implement not only the functionality described above with respect to the processor 904, but also to implement the functionality described above with respect to the signal detector 918, the DSP 920, the user interface 922, and/or the RWCP component 924. Further, each of the components illustrated in FIG. 9 may be implemented using a plurality of separate elements.

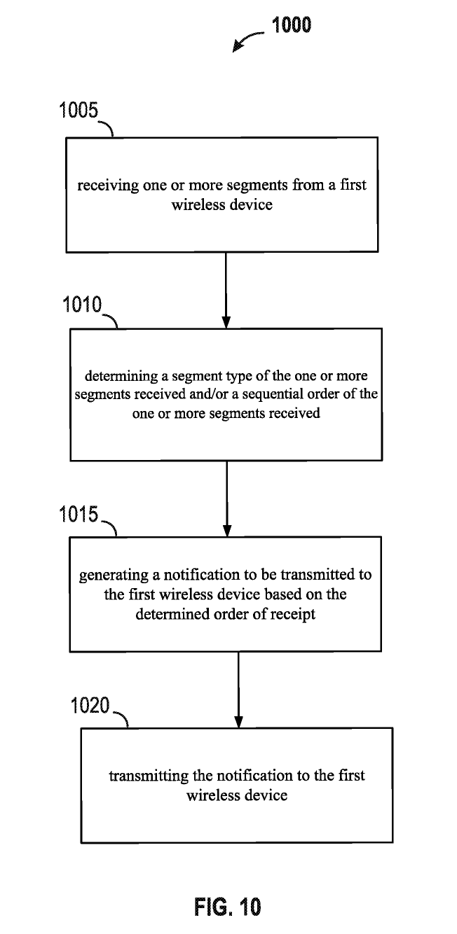

FIG. 10 is a flowchart of an exemplary method 1000 of wireless communication for transmitting information using a RWCP. The method 1000 may be performed using an apparatus (e.g., the fourth wireless device 240). Referring to FIG. 10, at 1005, the apparatus may receive one or more segments from a first wireless device. In an example, the one or more segments may be unreliable commands. For example, as shown by FIGS. 2, 3A-3B, and 4A-4B, the fourth wireless device 240 may receive WC 0-WC 5. In an example, once received, the apparatus may determine the type of segment received (e.g., data, SYN, or RST) and/or the sequential order of the received segment, at 1010. For example, referring to FIG. 5, firmware for the fourth wireless device 240 may check a RWCP header (e.g., 502) to determine the type of segment received. The RWCP header may include a command opcode field (e.g., 510) and/or a sequence number field (e.g., 512) that the fourth wireless device 240 may read to determine the segment type and the sequence order. At 1015, the apparatus may generate a notification to be transmitted to the first wireless device based on type of segment and/or the determined order of receipt. For example, as shown by FIG. 2, the fourth wireless device 240 may generate NT 0 in response to receiving WC 0. In some examples, in response to a data segment, the apparatus may generate a data ACK notification with a corresponding sequence order as the data segment of the notification. For example, in reference to FIGS. 2 and 5, the fourth wireless device 240 may receive a segment WC 3 having an RWCP header with opcode bits of 00 and sequence number of 00011, to indicate it is a data segment with the sequence number of 3, and in response to WC 3, the fourth wireless device 240 may generate notification NT 3 having an RWCP header with opcode bits of 00 and sequence number of 00011, to indicate an ACK of WC 3. In some examples, the fourth wireless device 240 may generate notification NT 3 to ACK receipt of all previously received segments such as WC 0-WC 3. Alternatively, if the apparatus determines that the data segment was sent out of sequence, the apparatus may generate a data ACK notification corresponding to a sequence order as the last received data segment received in sequence order. For example, in reference to FIGS. 4A and 5, the fourth wireless device 240 may receive a segment WC 4 having an RWCP header with opcode bits of 00 and sequence number of 00100, to indicate it is a data segment with the sequence number of 4. However, as the previously received segment was WC 2, the fourth wireless device 240 may determine that WC 4 was received out-of-sequence and therefore generate a notification NT 2 (or NT 2′) having an RWCP header with opcode bits of 11 and sequence number of 00010, to indicate that segments were received out-of-order and that the previously acknowledged segment was WC 2, again. In other words, in this example, the apparatus is configured to track the sequence order of segments received. At 1020, the apparatus may transmit the notification to the first wireless device.

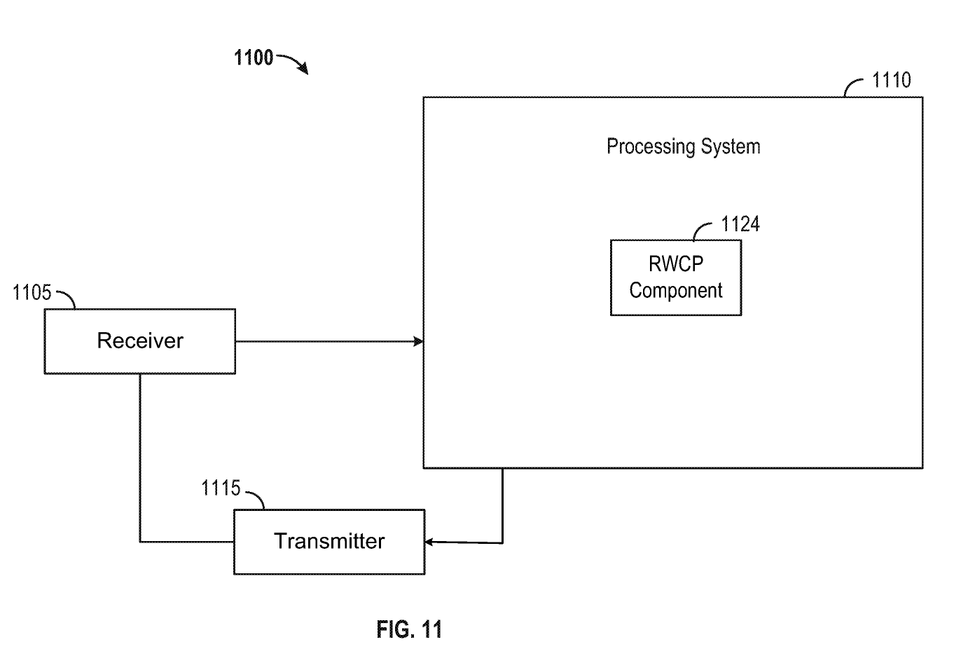

FIG. 11 is a functional block diagram of an exemplary wireless communication device 1100 for using an RWCP. The wireless communication device 1100 may include a receiver 1105, a processing system 1110, and a transmitter 1115. The processing system 1110 may include an RWCP component 1124. In an aspect, the RWCP component 1124 may be configured to receive one or more segments from a first wireless device. The one or more segments may be unreliable commands. In another aspect, the RWCP component 1124 may be configured to determine an order of receipt of the one or more segments. In another aspect, the RWCP component 1124 may be configured to generate a notification to be transmitted to the first wireless device based on the determined order of receipt. In another aspect, the RWCP component 1124 may be configured to transmit the notification to the first wireless device.

The receiver 1105, the processing system 1110, the RWCP component 1124, and/or the transmitter 1115 may be configured to perform one or more functions discussed above with respect to blocks 1005-1020 of FIG. 10. The receiver 1105 may correspond to the receiver 1112. The processing system 1110 may correspond to the processor 1104. The transmitter 1115 may correspond to the transmitter 910. The RWCP component 1124 may correspond to the RWCP component 924.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method for wireless communication by a first wireless device, comprising:
transmitting a first set of segments of a plurality of segments to a second wireless device;
determining whether a notification corresponding to one or more first segments of the first set of segments has been received from the second wireless device;
generating a second set of segments of the plurality of segments to be transmitted based on the determining whether the notification has been received; and
transmitting the second set of segments to the second wireless device, wherein each segment of the first set of segments and the second set of segments is an unreliable command.

2. The method of claim 1, further comprising sequentially numbering the plurality of segments, wherein the first set of segments and the second set of segments are transmitted in a sequential order based on the sequential numbering of the plurality of segments.

3. The method of claim 2, wherein the second set of segments is further determined based on a send window.

4. The method of claim 3, wherein the generating the second set of segments to be transmitted includes determining which of the one or more first segments in the first set of segments are within the send window and have not been acknowledged.

5. The method of claim 3, further comprising varying a size of the send window based on communication congestion between the first wireless device and the second wireless device.

6. The method of claim 2, wherein the determining whether a notification has been received comprises determining that no notification has been received, and wherein the generating the second set of segments comprises determining a segment that has not been previously acknowledged and is next in the sequential order to be acknowledged and including the segment in the second set of segments.

7. The method of claim 2, further comprising verifying a content of the notification when determined that the notification has been received, wherein the second set of segments is further determined based on the content of the notification.

8. The method of claim 7, wherein the verifying the content of the notification comprises determining that the content of the notification includes an acknowledgment of the one or more first segments of the first set of segments received in the sequential order, and
wherein the generating the second set of segments comprises determining a segment that has not been previously transmitted and is next in the sequential order to be transmitted and including the segment in the second set of segments.

9. The method of claim 7, wherein the verifying the content of the notification comprises determining that the content of the notification indicates that the one or more first segments of the first set of segments was received by the second wireless device out of sequence, and
wherein the generating the second set of segments comprises determining a segment that has not been previously acknowledged and is next in the sequential order to be acknowledged and including the segment in the second set of segments.

10. The method of claim 7, wherein the verifying the content of the notification comprises determining that the content of the notification indicates that one or more first segments of the first set of segments was not received by the second wireless device, and
wherein the generating the second set of segments comprises determining a segment that has not been previously acknowledged and is next in the sequential order to be acknowledged and including the segment in the second set of segments.

11. The method of claim 2, further comprising storing the plurality of segments in a buffer of the first wireless device, wherein the sequential order is based on a sequential order of the plurality of segments in the buffer and the first set of segments and the second set of segments are selected from the stored plurality of segments.

12. A method for wireless communication by a second wireless device, comprising:
receiving one or more segments from a first wireless device, wherein the one or more segments are unreliable commands;
determining an order of receipt of the one or more segments;
generating a notification to be transmitted to the first wireless device based on the determined order of receipt; and
transmitting the notification to the first wireless device.

13. The method of claim 12, wherein the determining the order of receipt comprises:
determining whether there is a gap in the one or more segments based on an expected sequential order and the determined order of receipt.

14. The method of claim 12, wherein the notification comprises an acknowledgment that the one or more segments were received in an expected sequential order.

15. The method of claim 12, wherein the notification comprises an acknowledgment of a previously acknowledged segment to indicate that the one or more segments were not received in an expected sequential order.

16. An apparatus for wireless communication, comprising:
means for transmitting a first set of segments of a plurality of segments to a second wireless device;
means for determining whether a notification corresponding to one or more first segments of the first set of segments has been received from the second wireless device;
means for generating a second set of segments of the plurality of segments based on whether the notification has been received; and
means for transmitting the second set of segments to the second wireless device, wherein each segment of the first set of segments and the second set of segments is an unreliable command.

17. The apparatus of claim 16, further comprising means for sequentially numbering the plurality of segments, wherein the first set of segments and the second set of segments are transmitted in a sequential order based on the sequential numbering of the plurality of segments.

18. The apparatus of claim 17, wherein the means for generating the second set of segments generates the second set of segments based on a send window.

19. The apparatus of claim 18, wherein the means for generating the second set of segments determines which of the one or more first segments in the first set of segments are within the send window and have not been acknowledged.

20. The apparatus of claim 18, further comprising means for varying a size of the send window based on communication congestion between the apparatus and the second wireless device.

21. The apparatus of claim 17, wherein the means for determining whether a notification has been received determines that no notification has been received, and wherein the means for generating the second set of segments determines a segment that has not been previously acknowledged and is next in the sequential order to be acknowledged and includes the segment in the second set of segments.

22. The apparatus of claim 17, further comprising means for verifying a content of the notification when determined that the notification has been received, wherein the means for generating the second set of segments generates the second set of segments based on the content of the notification.

23. The apparatus of claim 22, wherein the means for verifying the content of the notification determines that the content of the notification includes an acknowledgment of the one or more first segments of the first set of segments received in the sequential order, and
wherein the means for generating the second set of segments determines a segment that has not been previously transmitted and is next in the sequential order to be transmitted and includes the segment in the second set of segments.

24. The apparatus of claim 22, wherein the means for verifying the content of the notification determines that the content of the notification indicates that the one or more first segments of the first set of segments was received by the second wireless device out of sequence, and
wherein the means for generating the second set of segments determines a segment that has not been previously acknowledged and is next in the sequential order to be acknowledged and includes the segment in the second set of segments.

25. The apparatus of claim 22, wherein the means for verifying the content of the notification determines that the content of the notification indicates that one or more first segments of the first set of segments was not received by the second wireless device, and
wherein the means for generating the second set of segments determines a segment that has not been previously acknowledged and is next in the sequential order to be acknowledged and includes the segment in the second set of segments.

26. The apparatus of claim 17, further comprising means for storing the plurality of segments in a buffer of the apparatus, wherein the sequential order is based on a sequential order of the plurality of segments in the buffer and the first set of segments and the second set of segments are selected from the stored plurality of segments.

27. An apparatus for wireless communication, comprising:
means for receiving one or more segments from a first wireless device, wherein the one or more segments are unreliable commands;
means for determining an order of receipt of the one or more segments;
means for generating a notification to be transmitted to the first wireless device based on the determined order of receipt; and
means for transmitting the notification to the first wireless device.

28. The apparatus of claim 27, wherein the means for determining the order of receipt determines whether there is a gap in the one or more segments based on an expected sequential order and a determined order of receipt.

29. The apparatus of claim 27, wherein the notification comprises an acknowledgment that the one or more segments were received in an expected sequential order.

30. The apparatus of claim 27, wherein the notification comprises an acknowledgment of a previously acknowledged segment to indicate that the one or more segments were not received in an expected sequential order.

31. An apparatus for wireless communication, comprising:
a memory; and
one or more processors coupled to the memory and configured to:
transmit a first set of segments of a plurality of segments to a second wireless device;
determine whether a notification corresponding to one or more first segments of the first set of segments has been received from the second wireless device;
generating a second set of segments of the plurality of segments to be transmitted based on the determining whether the notification has been received; and
transmit the second set of segments to the second wireless device, wherein each segment of the first set of segments and the second set of segments is an unreliable command.

32. The apparatus of claim 31, wherein the one or more processors is further configured to sequentially number the plurality of segments, wherein the first set of segments and the second set of segments are transmitted in a sequential order based on the sequential numbering of the plurality of segments.

33. The apparatus of claim 32, wherein the second set of segments is further determined based on a send window.

34. The apparatus of claim 33, wherein the one or more processors is further configured to determine which of the one or more first segments in the first set of segments are within the send window and have not been acknowledged.

35. The apparatus of claim 33, wherein the one or more processors is further configured to vary a size of the send window based on communication congestion between the apparatus and the second wireless device.

36. The apparatus of claim 32, wherein the one or more processors is further configured to:
determine that no notification has been received;
determine a segment that has not been previously acknowledged and is next in the sequential order to be acknowledged; and
include the segment in the second set of segments.

37. The apparatus of claim 32, wherein the one or more processors is further configured to verify a content of the notification when determined that the notification has been received, wherein the second set of segments is further determined based on the content of the notification.

38. The apparatus of claim 37, wherein the one or more processors is further configured to:
determine that the content of the notification includes an acknowledgment of the one or more first segments of the first set of segments received in the sequential order;
determining a segment that has not been previously transmitted and is next in the sequential order to be transmitted: and include the segment in the second set of segments.

39. The apparatus of claim 37, wherein the one or more processors is further configured to:
determine that the content of the notification indicates that the one or more first segments of the first set of segments was received by the second wireless device out of sequence;
determine a segment that has not been previously acknowledged and is next in the sequential order to be acknowledged; and
include the segment in the second set of segments.

40. The apparatus of claim 37, wherein the one or more processors is further configured to:
determine that the content of the notification indicates that one or more first segments of the first set of segments was not received by the second wireless device;
determine a segment that has not been previously acknowledged and is next in the sequential order to be acknowledged; and
include the segment in the second set of segments.

41. The apparatus of claim 32, wherein the one or more processors is further configured to store the plurality of segments in a buffer of the apparatus, wherein the sequential order is based on a sequential order of the plurality of segments in the buffer and the first set of segments and the second set of segments are selected from the stored plurality of segments.

42. An apparatus for wireless communication, comprising:
a memory; and
one or more processors coupled to the memory and configured to:
receive one or more segments from a first wireless device, wherein the one or more segments are unreliable commands;
determine an order of receipt of the one or more segments;
generate a notification to be transmitted to the first wireless device based on the determined order of receipt; and
transmit the notification to the first wireless device.

43. The apparatus of claim 42, wherein the one or more processors is further configured to:
determine whether there is a gap in the one or more segments based on an expected sequential order and the determined order of receipt.

44. The apparatus of claim 42, wherein the notification comprises an acknowledgment that the one or more segments were received in an expected sequential order.

45. The apparatus of claim 42, wherein the notification comprises an acknowledgment of a previously acknowledged segment to indicate that the one or more segments were not received in an expected sequential order.

46. A computer-readable medium storing computer executable code, comprising code for:
transmitting a first set of segments of a plurality of segments to a second wireless device;
determining whether a notification corresponding to one or more first segments of the first set of segments has been received from the second wireless device;
generating a second set of segments of the plurality of segments to be transmitted based on the determining whether the notification has been received; and
transmitting the second set of segments to the second wireless device, wherein each segment of the first set of segments and the second set of segments is an unreliable command.

47. A computer-readable medium storing computer executable code, comprising code for:
receiving one or more segments from a first wireless device, wherein the one or more segments are unreliable commands;
determining an order of receipt of the one or more segments;
generating a notification to be transmitted to the first wireless device based on the determined order of receipt; and
transmitting the notification to the first wireless device.
